(19) United States
(12) Patent Application Publication
(10) Pub. No.: US 2020/0400225 A1
(43) Pub. Date: Dec. 24, 2020

(54) COMMERCIAL TRANSMISSION MODULAR CLUTCH-MAIN HOUSING

(71) Applicant: Eaton Cummins Automated Transmission Technologies, LLC, Galesburg, MI (US)

(72) Inventors: Timothy Scott SMITH, Paw Paw, MI (US); David L. WADAS, Kalamazoo, MI (US)

(21) Appl. No.: 16/899,857

(22) Filed: Jun. 12, 2020

Related U.S. Application Data
(60) Provisional application No. 62/863,261, filed on Jun. 19, 2019.

(51) Int. Cl. F16H 57/03; B60K 25/06; B60K 17/02; F16H 57/025

(52) U.S. Cl. CPC F16H 57/03; B60K 25/06; F16H 3/091; F16H 57/025; B60K 17/02

(57) ABSTRACT

A transmission housing includes a one-piece main housing including a generally annular wall structure cast from aluminum and including a plurality of axially extending raised ribs extending from a first axial end of the wall structure to a second axial end of the wall structure, a plurality of angularly extending raised ribs extending between at least some of the adjacent ones of the plurality of axially extending raised ribs. According to another aspect, the generally annular wall structure includes a plurality of wave structures extending axially along the wall structure.

### CROSS-REFERENCE TO RELATED APPLICATIONS

This application claims the benefit of U.S. Provisional Application No. 62/863261, filed on Jun. 19, 2019. The entire disclosure of the above application is incorporated herein by reference.

### FIELD

The present disclosure relates to a commercial transmission modular clutch-main housing.

### BACKGROUND

This section provides background information related to the present disclosure which is not necessarily prior art.

Transmissions serve a critical function in translating power provided by a prime mover to a final load. The transmission serves to provide speed ratio changing between the prime mover output (e.g. a rotating shaft) and a load driving input (e.g. a rotating shaft coupled to wheels, a pump, or other device responsive to the driving shaft). The ability to provide selectable speed ratios allows the transmission to amplify torque, keep the prime mover and load speeds within ranges desired for those devices, and to selectively disconnect the prime mover from the load at certain operating conditions.

Transmissions are subjected to a number of conflicting constraints and operating requirements. For example, the transmission must be able to provide the desired range of torque multiplication while still handling the input torque requirements of the system. Additionally, from the view of the overall system, the transmission represents an overhead device—the space occupied by the transmission, the weight, and interface requirements of the transmission are all overhead aspects to the designer of the system. Transmission systems are highly complex, and they take a long time to design, integrate, and test; accordingly, the transmission is also often required to meet the expectations of the system integrator relative to previous or historical transmissions. For example, a reduction of the space occupied by a transmission may be desirable in the long run, but for a given system design it may be more desirable that an occupied space be identical to a previous generation transmission, or as close as possible.

Previously known transmission systems suffer from one or more drawbacks within a system as described following. To manage noise, robustness, and structural integrity concerns, previously known high output transmission systems use steel for the housing of the transmission. Additionally, thrust loads through the transmission, noise generated by gears, and installation issues such as complex gear timing issues, require a robust and potentially overdesigned system in the housing, bearings, and/or installation procedures. Accordingly, there remains a need for improvements in the design of high output transmissions, particularly truck transmissions.

### SUMMARY

This section provides a general summary of the disclosure, and is not a comprehensive disclosure of its full scope or all of its features.

A transmission housing includes a one-piece main housing including a generally annular wall structure cast from aluminum and including a plurality of axially extending raised ribs extending from a first axial end of the wall structure to a second axial end of the wall structure, a plurality of angularly extending raised ribs extending between at least some of the adjacent ones of the plurality of axially extending raised ribs. According to another aspect, the generally annular wall structure includes a plurality of wave structures extending axially along the wall structure.

According to a further aspect of the present disclosure, an intermediate plate is mounted to a main housing and includes base plate and a pair of axially spaced reverse idler bosses for supporting a reverse idler shaft and a reverse idler gear. The pair of axially spaced reverse idler bosses are integrally formed as one piece with the intermediate plate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded perspective view of a transmission enclosure;

FIG. 2 is an assembled perspective view of the transmission assembly including the transmission enclosure shown in FIG. 1;

FIG. 3 is a left side rear perspective view of a main transmission housing according to the principles of the present disclosure;

FIG. 4 is a right side rear perspective view of the main transmission housing according to the principles of the present disclosure;

FIG. 5 is a bottom side rear perspective view of the main transmission housing according to the principles of the present disclosure;

FIG. 6 is cutaway perspective view of the main transmission housing according to the principles of the present disclosure;

FIG. 7 is a cross-sectional view of the transmission assembly according to the principles of the present disclosure;

FIG. 8 is a front perspective view of the machined intermediate plate of the transmission enclosure;

FIG. 9 is a front perspective view of the intermediate plate of the transmission enclosure as cast;

FIG. 10 is a front perspective view of the machined intermediate plate of the transmission closure having reverse idler gears mounted thereto;

FIG. 11A is a front perspective view of the idler boss and structural ribbing of the intermediate plate as cast;

FIG. 11 B is a rear perspective view of the idler boss of the intermediate plate as cast;

FIG. 12A is a front perspective view of the machined idler boss and structural ribbing of the intermediate plate;

FIG. 12B is a rear perspective view of the machined idler boss of the intermediate plate;

FIG. 13 is a front plan view of the machined intermediate plate; and

FIG. 14 is a rear plan of the machined intermediate plate.

Corresponding reference numerals indicate corresponding parts throughout the several views of the drawings.

### DETAILED DESCRIPTION

Example embodiments will now be described more fully with reference to the accompanying drawings

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

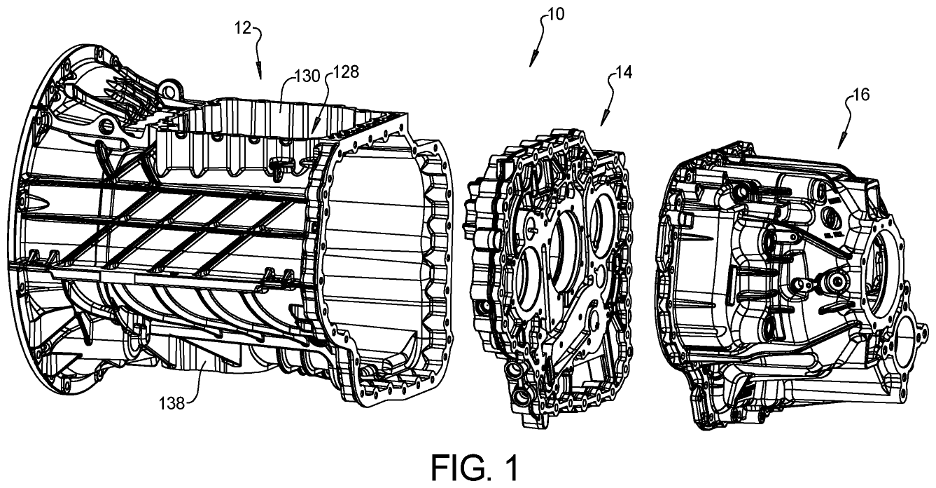

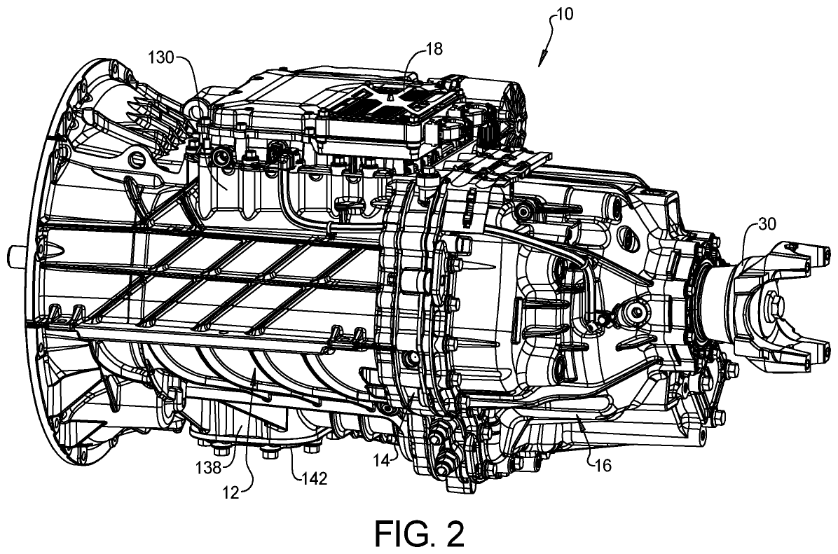

With reference to FIG. 1, an exploded perspective view of a transmission enclosure 10 is shown including a main housing 12, an intermediate plate 14 and a rear housing 16. As shown in FIG. 2, the transmission enclosure 10 is assembled with the intermediate plate 14 assembled to a rear end of the main housing 12 and the rear housing 16 is mounted to the intermediate plate 14. An integrated actuator housing 18 is mounted to the main housing 12.

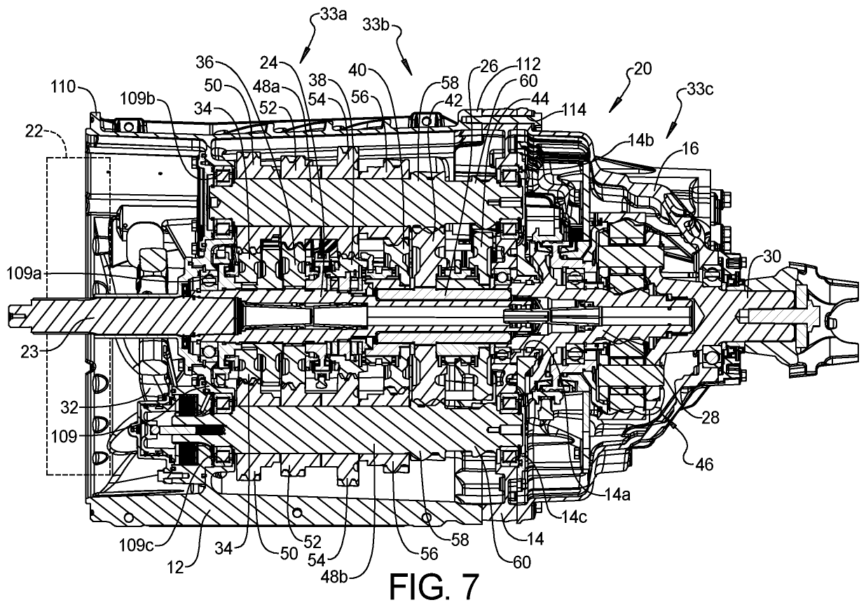

As shown in FIG. 7, an exemplary assembled transmission 20 is depicted schematically in a cutaway view. The cutaway plane in the example of FIG. 7 is a horizontal plane through the transmission 20. The example transmission 20 is capable of providing power throughput from a prime mover (not shown) interfacing with a clutch unit 22 (schematically shown) to an input shaft 23, from the input shaft 23 to an extension shaft 24, from the extension shaft 24 to a main shaft portion 26, from the main shaft portion to a range shaft portion 28, and from the range shaft portion 28 to an output shaft assembly 30. The example transmission 20 is operable to adjust torque multiplication ratios throughout the transmission, to engage and disengage the clutch unit 22 from the prime mover (not shown), and/or to position the transmission 20 into a neutral position wherein, even if the clutch unit 22 is engaged to the prime mover, torque is not transmitted from the clutch unit 22 to the output shaft assembly 30.

With further reference to FIG. 7, a clutch engagement yoke 32 is provided for engagement of the clutch unit 22 with the prime mover. The example clutch engagement yoke 32 is operationally coupled at a first end to a clutch actuator. In certain embodiments of the present disclosure, any type of clutch actuation may be utilized, including a concentric clutch actuator (not shown) and/or another type of linear clutch actuation device.

The example transmission 20 includes a splitter section 33A, a main box section 33B and a range gear section 33C to provide multiple gear ratios. The splitter section 33A includes a first splitter gear 34, a second splitter gear 36 and a third splitter gear 38 each selectively coupled to the extension shaft 24. The inclusion of the splitter gears 34, 36, 38 allow for additional distinct gear ratios provided by the extension shaft 24.

The main box section 33B of the example transmission 20 further includes a number of main box gears 40, 42, 44 selectively coupled to the main shaft portion 26.

The range gear section 33C of the example transmission 20 further includes a planetary gear assembly 46 that couples the range shaft portion 28 to the output shaft assembly 30 through at least two selectable gear ratios between the range shaft portion 28 and the output shaft assembly 30.

The example transmission 20 further includes at least one countershaft 48a, 48b, the countershafts 48a, 48b having three aligning gears 50, 52, 54 within the splitter section 33A and drivingly engaged with the respective first, second and third splitter gears 34, 36, 38 on the extension shaft 24. The countershafts 48a, 48b further includes three aligning gears 56, 58, 60 within the main box section 33B and drivingly engaged with the respective first, second and third main box gears 40, 42, 44 selectively coupled to the main shaft portion 26. With the three gears in the splitter section 33A, the three gears in the main box section 33B and the two gear ratios provided by the range gear section 33C, the transmission 20 provides a 3×3×2 transmission that is operable to provide 18 practical and functional gear ratios. The number and selection of gears depends upon the desired number of gear ratios from the transmission.

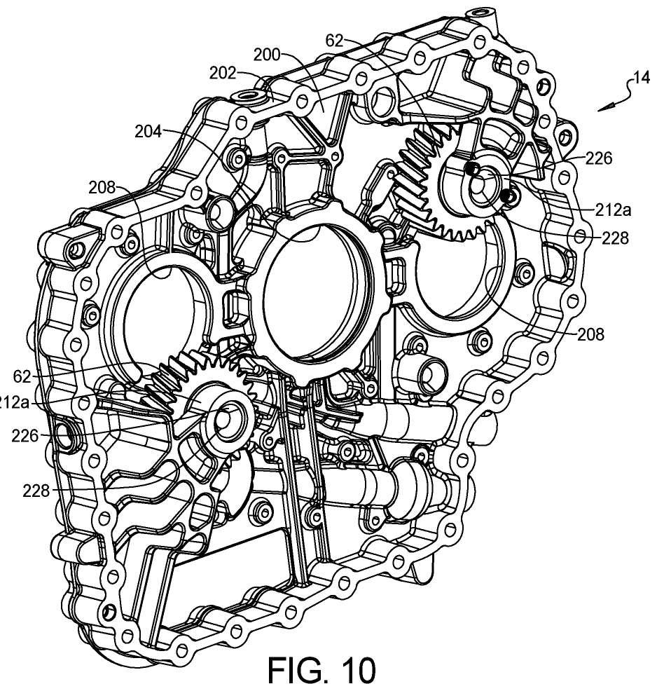

The transmission includes a pair of reverse idler gears 62 (best shown in FIG. 10) that engage with the aligning gears 60 of the countershafts 48a, 48b and with the main box gear 44 of the first main shaft portion 26. The countershaft(s) 48a, 48b thereby selectively transmit forward or reverse power between the extension shaft 24 and the main shaft portion 26, depending upon which gears are rotationally fixed (via clutches) to the extension shaft 24 and/or the main shaft portion 26.

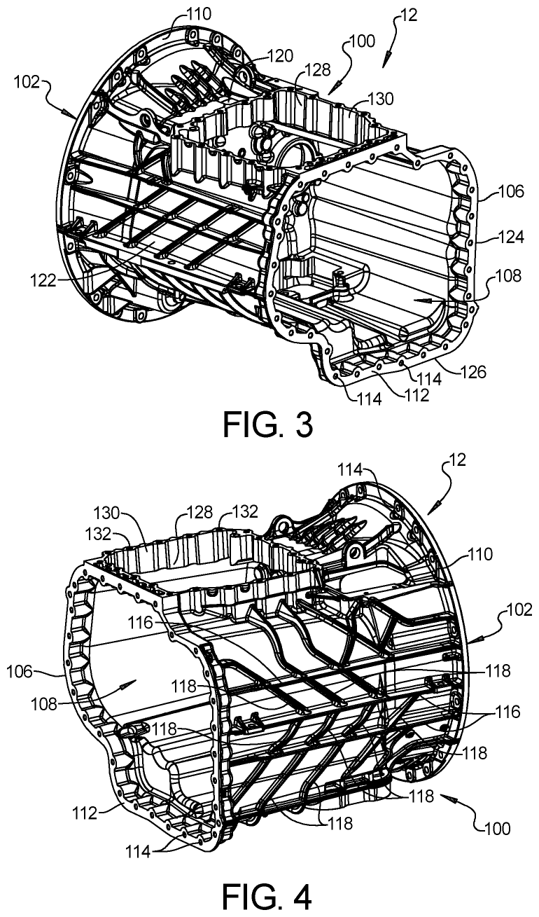

With reference to FIGS. 3-5, the main housing 12 includes a one-piece generally annular wall structure 100 made from cast aluminum. A front end 102 of the main housing 12 can define a clutch chamber 104 for receiving the clutch engagement yoke 32 of the clutch unit 22. A rear end 106 of the main housing 12 defines a transmission main chamber 108 for receiving the second main shaft portion 26 and the range shaft portion 28 and the countershafts 48a, 48b. As best shown in FIGS. 6 and 7, a partition wall 109 is disposed between the clutch chamber 104 and the transmission main chamber 108 and is integrally formed with the one-piece generally annular wall structure 100. The partition wall 109 includes a plurality of openings 109a, 109b, 109c for receiving and supporting the extension shaft 24 and a first end of the countershafts 48a, 48b. The intermediate plate 14 includes a plurality of openings 14a, 14b, 14c for receiving and supporting the main shaft 26 and the range shaft 28 and a second end of the countershafts 48a, 48b.

With reference to FIGS. 3-5, the one-piece generally annular wall structure 100 of the main housing 12 has a forward mounting flange 110 and a rearward mounting flange 112 each having a plurality of apertures or bores 114 for receiving fasteners therein. The annular wall structure 100 can have a wall thickness of between 5.0 and 7.0 mm and preferably 6.0 mm in order to provide a reduced weight aluminum housing.

In order to further strengthen the annular wall structure 100 a plurality of axially extending raised ribs 116 can extend longitudinally from the front end 102 to the rear end 106 of the main housing 12. The axially extending raised ribs 116 provide part structure, reduce frequencies of the large panels of the main housing 100, and support material flow throughout the structure during casting of the main housing 100. In addition, a plurality of angularly extending raised ribs 118 extend diagonally between adjacent ones of the plurality of axially extending raised ribs 116. By “diagonally,” it is meant that the plurality of angularly extending raised ribs 118 extend at an acute (non-perpendicular) angle from the axially extending raised ribs 116. The angularly extending raised ribs 118 provide part structure by connecting the longitudinal ribs 116 and further aid in material flow during casting of the main housing 100 thereby reducing turbulence and mitigating porosity.

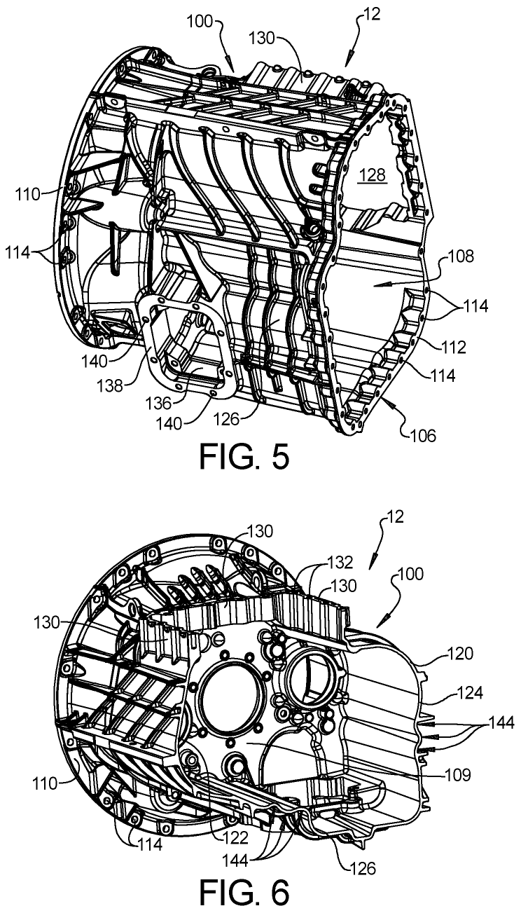

As shown in FIG. 3, the one-piece generally annular wall structure 100 can include a top wall portion 120, a left side wall portion 122, a right side wall portion 124, and a bottom wall portion 126. The top wall portion 120 can include an actuator interface opening 128 with an actuator wall structure 130 extending radially outward from the top wall portion 120 of the generally annular wall structure 100. The actuator wall structure 130 can include a plurality of bores 132 for receiving fasteners for securing the actuator housing 18 within the actuator interface opening 128. As best shown in FIG. 5, the bottom wall portion 126 can include a PTO interface opening 136 with a PTO wall structure 138 extending radially outward from the bottom wall portion 126 of the generally annular wall structure 100. The PTO wall structure 138 can include a plurality of bores 140 for receiving fasteners for securing a PTO cover 142 over the PTO interface opening 136.

With reference to FIG. 6, a cut section of the main housing 12 is shown including a plurality of waves 144 disposed in the bottom wall portion 126 and the right sidewall portion 124. The waves 144 define an undulating surface and extend axially along the generally annular wall structure 100 and break up large flat panels of the wall portions 126, 124 by providing additional strength and reduced frequencies.

The design of the aluminum main housing 12 provides for a reduced weight housing with the required strength and noise reduction. The aluminum main housing 12 is also economically castable.

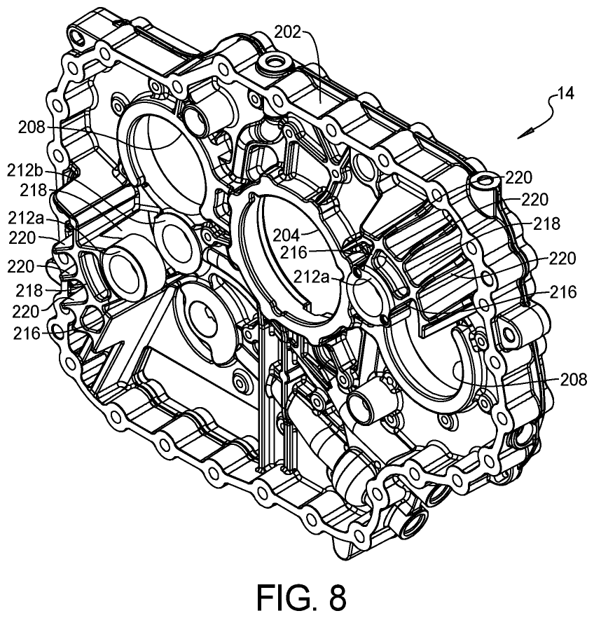

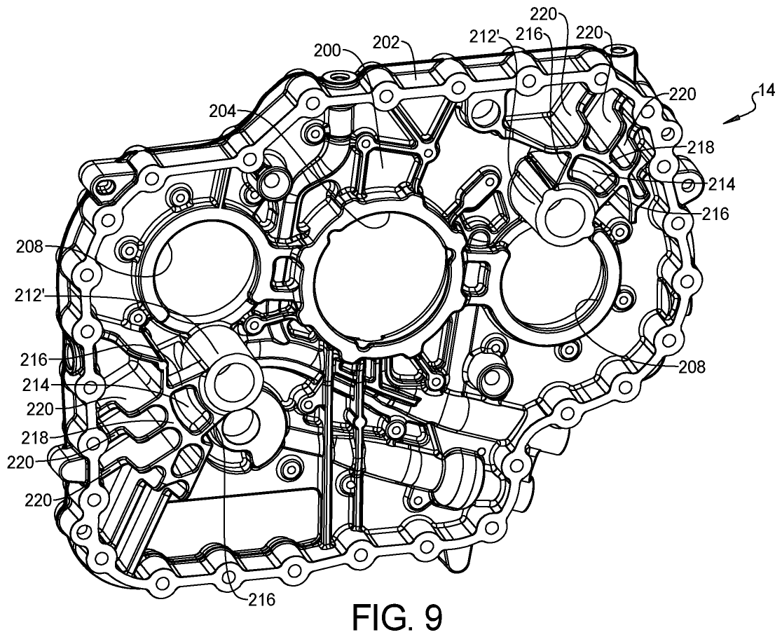

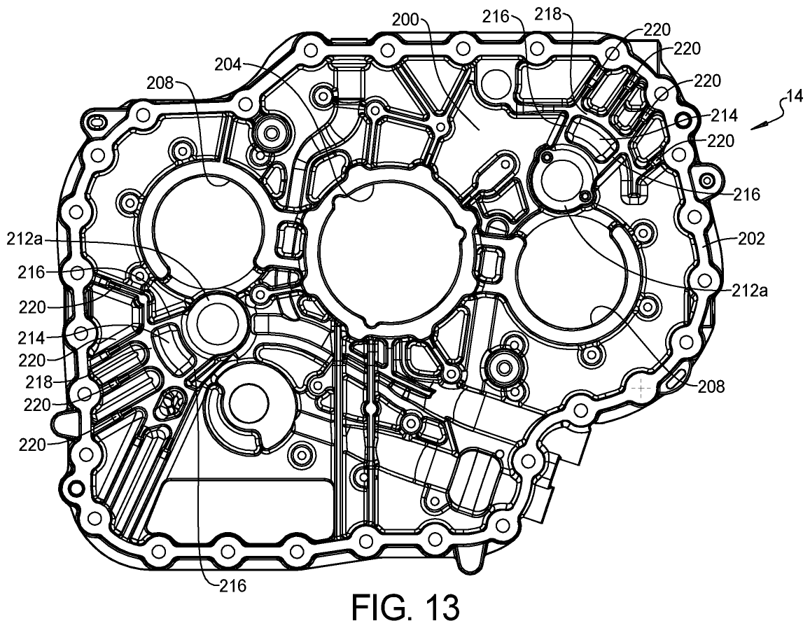

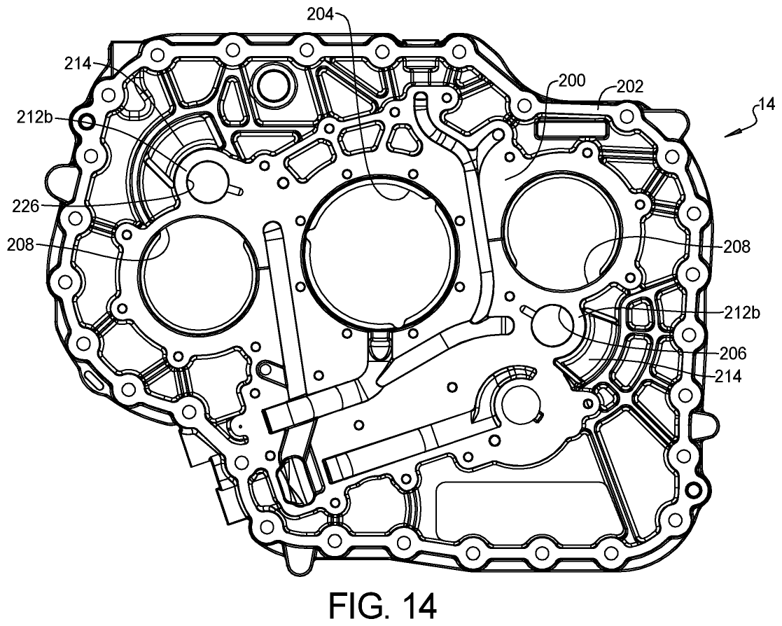

With reference to FIGS. 8-14, the intermediate plate 14 of the transmission housing 10 will now be described. As shown in FIG. 8, the intermediate plate 14 includes a plate-like base 200 having a peripheral flange portion 202 extending around the plate-like base 200. The plate-like base 200 includes a center opening 204 for receiving a bearing 206 (best shown in FIG. 7) for supporting the extension shaft 24, first main shaft portion 26 and second main shaft portion 28. The plate-like base 200 includes a pair of openings 208 laterally offset from the center opening 204 for receiving bearings 210 for supporting the countershafts 48a, 48b. The intermediate plate 14 further includes two pairs of axially spaced reverse idler support bosses 212a, 212b for supporting the pair of reverse idler gears 62, as best shown in FIG. 10. The support bosses 212a are supported by a bridge wall 214 including a pair of side ribs 216, a mid-wall 218 and additional structural ribs 220 that extend from the mid wall 218 to the peripheral flange 202.

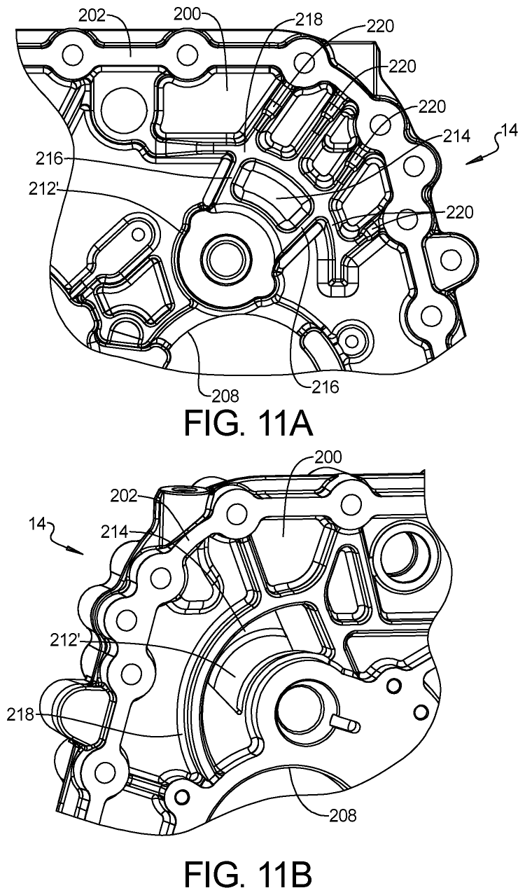

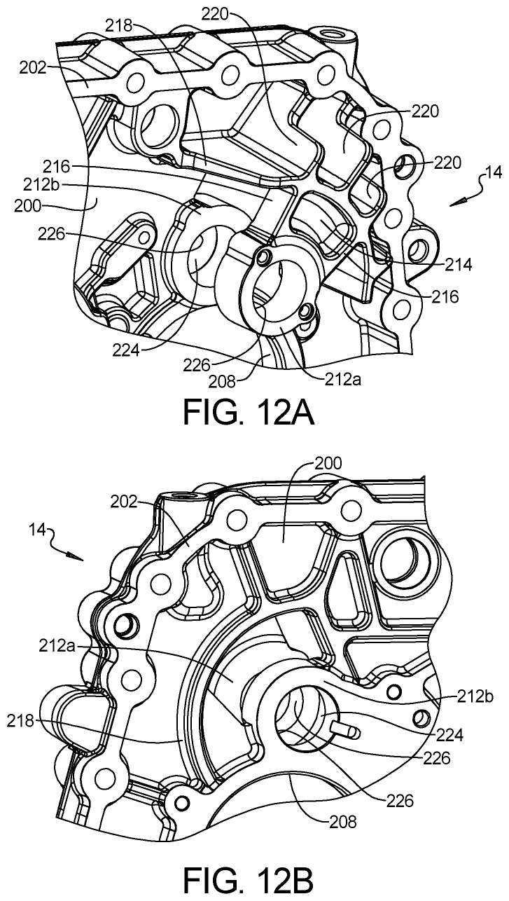

As shown in FIGS. 11A and 11B the intermediate plate 14, as cast includes a solid idler boss 212′ that is formed from front and rear die segments that are pulled in opposite forward and rearward directions. The front die forms the forward surface as shown in FIG. 11A and the rear die forms the rearward surface as shown in FIG. 11B including the cavity 222. As shown in FIGS. 12A and 12B, the solid idler boss 212′ is machined to form a gap 224 between the pairs of reverse idler support bosses 212a, 212b. The gap 224 between the pairs of reverse idler support bosses 212a, 212b is designed to receive the reverse idler gears 62, as illustrated in FIG. 10. In addition, the reverse idler bosses 212a, 212b are each machined to include an opening 226 there through. As shown in FIG. 10, the openings 226 support a reverse idler shaft 228 that supports the reverse idler gear 62. The reverse idler gears 62 each engage one of the aligning gears 60 of the countershafts 48a, 48b and with the gear 44 of the first main shaft portion 26.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A transmission housing, comprising:
a one-piece main housing including a generally annular wall structure cast from aluminum and including a plurality of axially extending raised ribs extending from a first axial end of the wall structure to a second axial end of the wall structure and a plurality of angularly extending raised ribs extending between at least some of the adjacent ones of the plurality of axially extending raised ribs.

2. The transmission housing according to claim 1, wherein the generally annular wall structure includes a plurality of wave structures extending axially along the wall structure.

3. The transmission housing according to claim 1, wherein the generally annular wall structure includes an actuator interface opening.

4. The transmission housing according to claim 3, further comprising an actuator wall structure extending radially outward from the annular wall structure and surrounding the actuator interface opening.

5. The transmission housing according to claim 1, wherein the generally annular wall structure includes a PTO interface opening.

6. The transmission housing according to claim 5, further comprising a PTO wall structure extending radially outward from the annular wall structure and surrounding the PTO interface opening.

7. The transmission housing according to claim 1, further comprising a partition wall formed integrally with the one-piece main housing disposed between a clutch chamber and a transmission chamber.

8. A transmission housing, comprising:
a one-piece main housing including a generally annular wall structure cast from aluminum, wherein the generally annular wall structure includes a plurality of wave structures extending axially along the wall structure.

9. The transmission housing according to claim 8, wherein the generally annular wall structure includes an actuator interface opening.

10. The transmission housing according to claim 9, further comprising an actuator wall structure extending radially outward from the annular wall structure and surrounding the actuator interface opening.

11. The transmission housing according to claim 8, wherein the generally annular wall structure includes a PTO interface opening.

12. The transmission housing according to claim 11, further comprising a PTO wall structure extending radially outward from the annular wall structure and surrounding the PTO interface opening.

13. The transmission housing according to claim 8, further comprising a partition wall formed integrally with the one-piece main housing disposed between a clutch chamber and a transmission chamber.

14. A transmission, comprising:
a one-piece main housing including a generally annular wall structure cast from aluminum, a partition wall formed integrally with the one-piece main housing and disposed between a clutch chamber and a transmission chamber, wherein a first axial end of the one-piece main housing includes the clutch chamber and a second axial end of one-piece main housing includes the transmission chamber;
a clutch of the transmission disposed at least partially in the clutch chamber; and
a main shaft and at least one countershaft disposed in the transmission chamber , the main shaft including a plurality of main shaft gears mounted thereon and the at least one countershaft including a plurality of countershaft gears engaging with the main shaft gears.

15. The transmission housing according to claim 14, wherein the one-piece main housing includes a plurality of axially extending raised ribs extending from a first axial end of the wall structure to a second axial end of the wall structure, a plurality of angularly extending raised ribs extending between at least some of the adjacent ones of the plurality of axially extending raised ribs.

16. The transmission housing according to claim 14, wherein the generally annular wall structure includes a plurality of wave structures extending axially along the wall structure.

17. The transmission housing according to claim 14, wherein the generally annular wall structure includes an actuator interface opening.

18. The transmission housing according to claim 18, further comprising an actuator wall structure extending radially outward from the annular wall structure and surrounding the actuator interface opening.

19. The transmission housing according to claim 14, wherein the generally annular wall structure includes a PTO interface opening.

20. The transmission housing according to claim 19, further comprising a PTO wall structure extending radially outward from the annular wall structure and surrounding the PTO interface opening.

21. A transmission, comprising:
a main housing having a shaft system supported within the main housing and including a plurality of gears supported by the shaft system, the shaft system including at least one countershaft and at least one reverse idler shaft supporting a reverse idler gear engaged with two of the plurality of gears supported by the shaft system,
an intermediate plate mounted to the main housing and including a base plate and a pair of axially spaced reverse idler bosses for supporting the reverse idler shaft and the reverse idler gear, the pair of axially spaced reverse idler bosses being integrally formed as one piece with the intermediate plate.

22. The transmission according to claim 21, wherein one of the pair of spaced reverse idler bosses is supported by a bridge wall integrally formed with the one of the pair of spaced reverse idler bosses and the intermediate plate.

23. The transmission according to claim 22, wherein the bridge wall includes a pair of side ribs.

24. The transmission according to claim 22, wherein the bridge wall extends from a mid wall that is reinforced with a plurality of structural ribs that extend from the mid wall to a peripheral flange extending around a periphery of the base plate.

25. A transmission, comprising:
a countershaft gear train system including a splitter section, a main box section and a range gear section having a main shaft and at least one countershaft defining a 3×3×2 gearing architecture;
a one-piece main housing including a generally annular wall structure cast from aluminum, wherein a first axial end of the one-piece main housing includes a clutch chamber and a second axial end of the one-piece main housing includes a transmission chamber that houses the splitter section and the main box section of the countershaft gear train system;
a clutch disposed at least partially in the clutch chamber of the one-piece main housing and providing drive torque to the countershaft gear train system.

26. The transmission according to claim 25, wherein the one-piece main housing includes a partition wall formed integrally within the one-piece main housing and disposed between the clutch chamber and the transmission chamber.

27. The transmission according to claim 25, further comprising an intermediate plate mounted to the one-piece main housing and including a base plate and a pair of axially spaced reverse idler bosses for supporting a reverse idler shaft and a reverse idler gear, the pair of axially spaced reverse idler bosses being integrally formed as one piece with the intermediate plate.

28. The transmission according to claim 25, wherein the generally annular wall structure includes a PTO interface opening.
